(19) United States
(12) Patent Application Publication
(10) Pub. No.: US 2011/0153728 A1
(43) Pub. Date: Jun. 23, 2011

(54) SYNCHRONIZATION OF SPORADIC WEB POLL TRAFFIC

(75) Inventors: Torbjörn EINARSSON, Stockholm (SE); Per-Erik BRODIN, Sollentuna (SE); Per WILLARS, Vaxholm (SE)

(73) Assignee: TELEFONAKTIEBOLAGET LM ERICSSON (PUBL), Stokholm (SE)

(21) Appl. No.: 12/725,562

(22) Filed: Mar. 17, 2010

Related U.S. Application Data
(60) Provisional application No. 61/287,454, filed on Dec. 17, 2009.

(51) Int. Cl. G06F 15/16

(52) U.S. Cl. 709/203; 713/323

(57) ABSTRACT

Polling performed by multiple applications running on a device is coordinated. A central scheduling function can, for example, periodically issue polling event messages to the applications. The applications can, in turn, request the transmission of polling signals to their respective servers to request application updates. By coordinating transmission of polling signals battery consumption and network communication resources can be optimized.

### RELATED APPLICATION

This application is related to, and claims priority from, U.S. Provisional Patent Application Ser. No. 61/287,454, filed on Dec. 17, 2009, entitled “Synchronization of Sporadic Web Poll Traffic”, the entire disclosure of which is incorporated here by reference.

### TECHNICAL FIELD

The present invention generally relates to communication systems, nodes, devices, software and methods and, more particularly, to mechanisms and techniques for synchronizing updates of client applications.

### BACKGROUND

Many applications which run on end-user devices (e.g., personal computers, mobile phones, PDAs, etc.) are networked these days. While some applications require or permit user-initiated downloading of data from the web, there are many applications that frequently poll servers for more data, status updates, or notifications. Such data can also be pushed to clients, typically via long-hanging HTTP poll techniques, a.k.a. COMET technology. Some such applications include RSS readers, Facebook clients, instant-messaging (IM) and email/pushmail clients, just to name a few.

Typically, such networked client applications poll their respective servers periodically, e.g., every few minutes. Often, the user is able to configure the poll interval in the settings of the application client, e.g., to set the polling interval to be every minute, every few minutes, every 10 minutes, etc. If a device is running many such client applications, then there might be a poll request transmitted by that device every minute even if the polling interval for each of the client applications is greater than 10 minutes, i.e., due to the large number of applications polling their respective servers. Thus, the number of sporadic traffic events (transmit and receive) might therefore be very high, even if there are relatively few status updates being made by the respective services associated with the client applications.

As an alternative to polling, push mechanisms using long-hanging HTTP polls or WebSockets have been suggested and deployed, for example in Apple's iPhone PushNotification mechanism. In other updating techniques, only a single TCP connection is established towards a gateway. HTTP GET requests are issued, and not returned by the server, until there is an event on the server, or a timeout has occurred. For low activity traffic, this results in very little sporadic traffic over the network, and if the timeouts in the operator gateways, firewalls and NATs are set appropriately, one can have a system with short delivery time, but with low power consumption. However, this approach requires a centralized server side, and changes to the client and server protocols, and can lead to high power consumption if there is frequent sporadic traffic. For example, an update with every twitter tweet, can lead to updates every minute or more.

For fixed Internet connections, the traffic patterns resulting from these polls and pushes are normally not a problem. However, for cellular networks and mobile end user devices, each network activity typically results in a corresponding drain on the device's battery as the radio is turned on and stays on for some time, which leads to a relatively high overhead in this process. For some users and Circumstances, a short notification time may be more important than a long battery life, but in many cases battery life-time is more important.

Thus, this situation poses potentially significant problems when the client device (and its multiple polling applications) communicate with the various servers via an air interface, i.e., a radio link, e.g., for mobile phones running such applications. For such devices, each time the device has to “wake up” from a lower power state to transmit a polling request, power is used from its battery. Moreover, the limited air interface resources are consumed by the corresponding network signaling associated with the device's wakeup. Consider FIG. 1 which depicts a histogram 100 illustrating this problem.

Therein, a first client application (App1) has a polling periodicity of 20 minutes. Thus, for example, App1 requests the device to send a polling request message to its respective server at time t=1 and then later at time t=21. If asleep, the device transitions from sleep mode, performs the necessary network handshaking, transmits a polling request over an air interface for App1, potentially awaits a response and then re-enters sleep mode. App 2, App 3, App 4 and App 5 (which are also running on the same device as App 1) have polling periodicities of ten minutes and perform the same operations as described above for App1 at time instants t=3 and t=13, t=5 and t=15, t=7 and t=17 and t=9 and t=19, respectively. Thus, as shown in the “Radio Activity” line of the histogram of FIG. 1, the device's radio may be active for five time intervals in every 10 minutes just due to multiple client applications polling their respective servers for updates which may or may not be present.

Of course it will be appreciated that the example shown in FIG. 1 is purely illustrative and that in operation the pseudo-random nature of application activation, polling periodicity and other factors may result in some applications polling at the same time or at nearly the same time, i.e., the distribution of polling requests may vary. Nonetheless, the more client applications which a device is running at a given time, the more likely it is that the device's radio transceiver will be used more frequently to transmit polling requests, thereby using more battery power and network resources.

Accordingly, it would be desirable to provide devices, systems, methods and software which address this problem.

### SUMMARY

The following exemplary embodiments provide a number of advantages and benefits relative to existing client application updating software, devices and methods including, for example, the possibility to reduce the number of times during which a device, e.g., including a radio transceiver, is operative to transmit polling requests. It will be appreciated by those skilled in the art, however, that the claims are not limited to those embodiments which produce any or all of these advantages or benefits and that other advantages and benefits may be realized depending upon the particular implementation.

According to one exemplary embodiment, a device includes a processor configured to simultaneously execute multiple applications each of which periodically receive updates from respective servers and to execute a central scheduling function which periodically transmits a polling event message to the multiple applications, and a communication interface configured to transmit, in response to the polling event message, a plurality of polling signals from the device, the polling signals being associated with the multiple applications which received the polling event message.

According to another exemplary embodiment, a method for polling servers from a device includes the steps of receiving, at multiple applications which are running simultaneously on the device, a polling event message, and transmitting, in response to the polling event message, a plurality of polling signals from the device, the polling signals being associated with the multiple applications which received the polling event message.

### BRIEF DESCRIPTION OF THE DRAWINGS

The accompanying drawings, which are incorporated in and constitute a part of the specification, illustrate one or more embodiments and, together with the description, explain these embodiments. In the drawings:

FIG. 1 is a histogram depicting radio activity associated with multiple applications operating on a single client device requesting updates;

FIG. 2 depicts multiple applications operating on a single client device communicating with respective servers;

FIG. 3 shows multiple applications subscribing to a central scheduling function, and receiving poll events, according to an exemplary embodiment;

FIG. 4 is a histogram depicting radio activity associated with multiple applications operating on a single client device requesting updates using synchronized polling according to an exemplary embodiment;

FIGS. 5 and 6 are flow diagrams which depict methods for synchronized updating of applications according to exemplary embodiments;

FIG. 7 shows an exemplary client device on which multiple applications can be operating using synchronized updating according to an exemplary embodiment;

FIG. 8 shows an exemplary server device which can send updates to a client device according to exemplary embodiments; and

FIG. 9 is a flowchart illustrating a method for polling servers according to an exemplary embodiment.

### DETAILED DESCRIPTION

The following description of the exemplary embodiments refers to the accompanying drawings. The same reference numbers in different drawings identify the same or similar elements. The following detailed description does not limit the invention. Instead, the scope of the invention is defined by the appended claims. The following embodiments are discussed, for simplicity, with regard to the terminology and structure of presence systems described below. However, the embodiments to be discussed next are not limited to these systems but may be applied to other existing communication systems.

Reference throughout the specification to “one embodiment” or “an embodiment” means that a particular feature, structure, or characteristic described in connection with an embodiment is included in at least one embodiment of the present invention. Thus, the appearance of the phrases “in one embodiment” or “in an embodiment” in various places throughout the specification are not necessarily all referring to the same embodiment. Further, the particular features, structures or characteristics may be combined in any suitable manner in one or more embodiments.

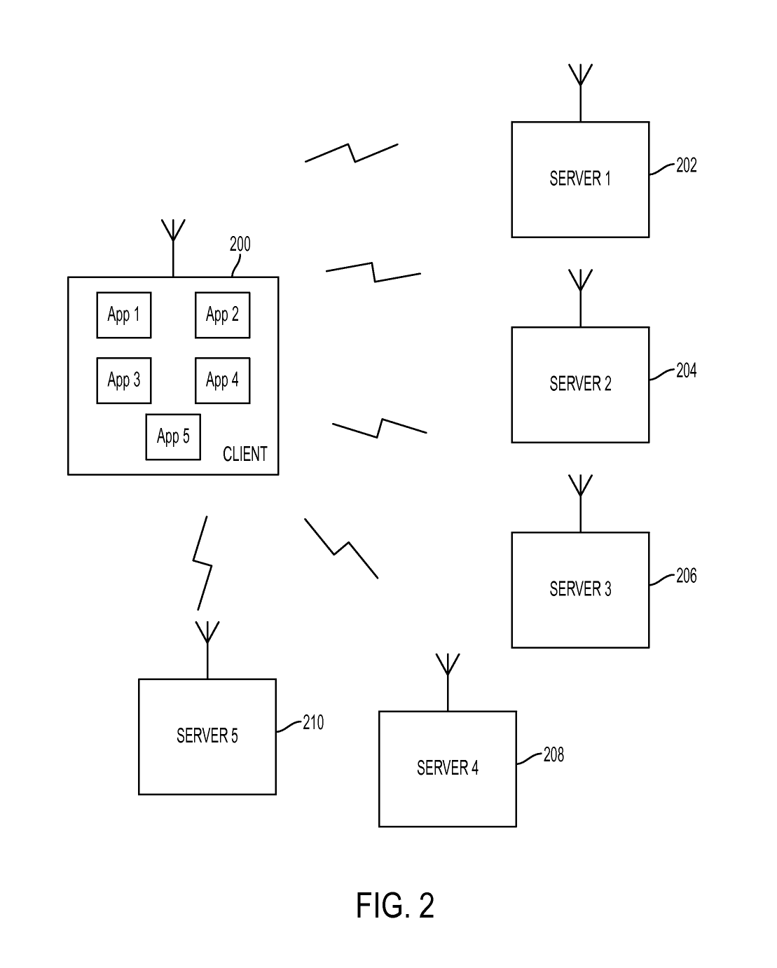

According to exemplary embodiments, a central update scheduling function is provided within the client device which synchronizes the update traffic associated with client applications, so that there are relatively infrequent, but well-used intervals when the radio is used, i.e., so that such update or polling traffic is less sporadic. Consider for example, an exemplary embodiment associated with the polling traffic in the context of the client device of FIG. 2. Therein, a client device (or user equipment) 200 is running five applications (App1-App5) each of which need periodic updates, e.g., of content, status, etc. These applications are active at the same time and are dependent on updating their state, content or other data from servers via a network connection. These updates are performed by polling the server for updated status or new events, and downloading corresponding data. Thus each application triggers the transmission of a polling signal from the client device 20 toward a respective server 202-210.

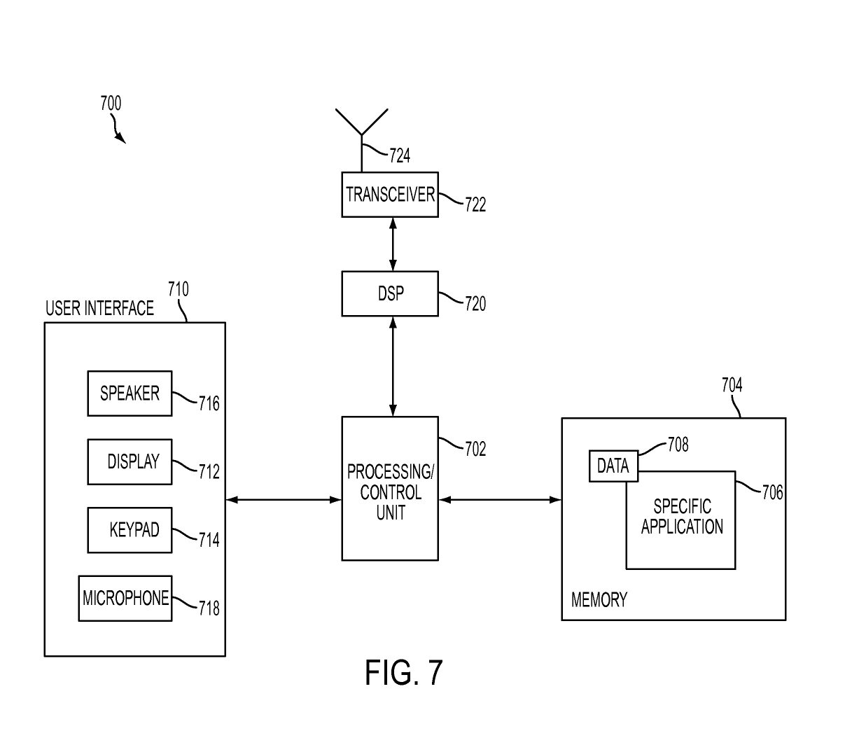

In this example, the client device 200 includes a wireless transceiver (not shown in FIG. 2) over which to request and/or receive such updates, however the present invention is not limited to client devices which use wireless communication interfaces, but can also be applied e.g., to those which use wireline interfaces to obtain updates. More details regarding an exemplary client device 200 are provided below with respect to FIG. 7.

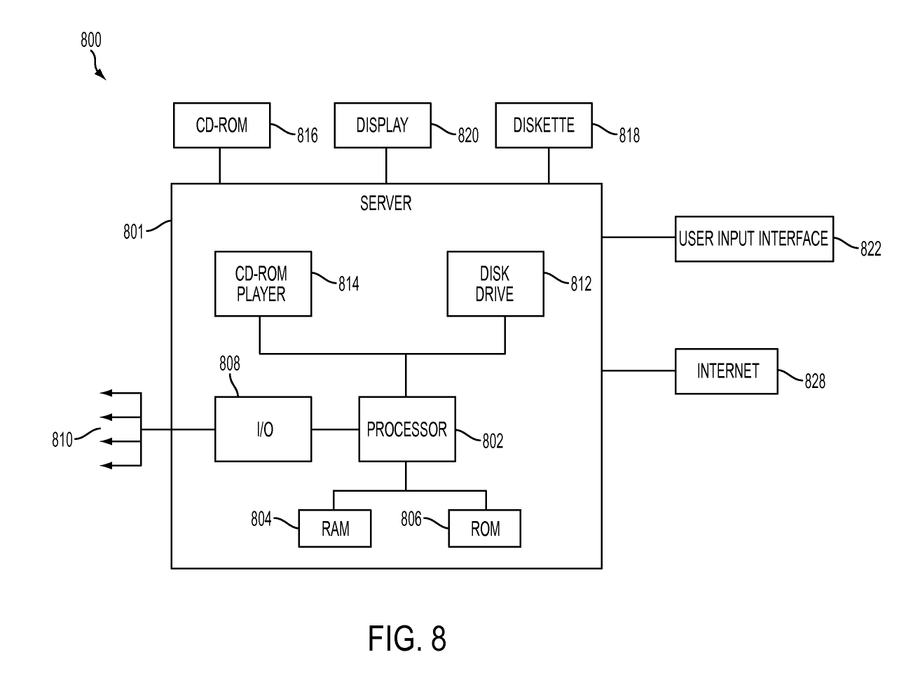

In this example, each client application App1-App5 periodically requests updates from a respective server 202, 204, 206, 208 and 210. Request signals are transmitted wirelessly over an air interface to a transceiver (not shown) in the server. Responsive updates are sent to the client device 200 as signals over the same air interface. More details regarding exemplary server equipment are provided below with respect to FIG. 8.

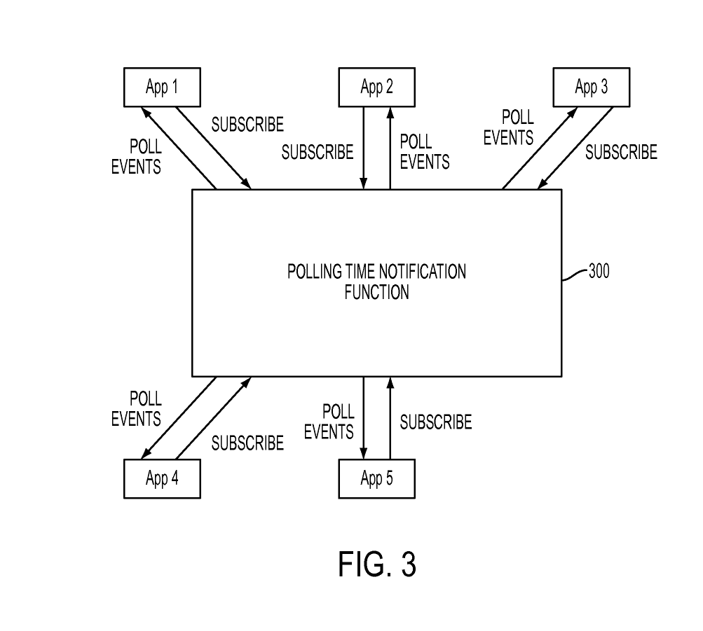

According to an exemplary embodiment, in order to synchronize the polling requests, each of the client applications App1-App5 subscribes to a central scheduling function, shown as the pollingTimeNotification function 300 in FIG. 3, by sending a subscription message thereto. The pollingTimeNotification function 300 can, for example, be implemented as a software application running on a processor or set of processors within client device 200, e.g., the same processor(s) which also execute the client applications App1-App5. The subscription message which is sent to the pollingTimeNotification function 300 can, for example, indicate only that the corresponding application wishes to subscribe to the polling service and that, therefore, the subscribing client application will only request that polling messages be sent when the subscribing client application receives permission (e.g., via a polling event signal) from the central scheduling function 300. Alternatively, the subscription message can include other information, e.g., a preferred periodicity at which the application would like to send polling requests to its corresponding server. Moreover, the subscription aspect may be omitted, e.g., polling signal control according to other exemplary embodiments can be mandatory thus rendering subscription unnecessary.

As mentioned above, the central scheduler function 300 can be implemented as software and/or hardware in the client device 200 and, according to this exemplary embodiment, broadcasts individual pollingTimeNotification event messages at regular intervals, for example every 10 minutes. Those skilled in the art will appreciate that the specific periodicity selected for the central scheduling function 300 to transmit a polling event message to its subscribed client applications can vary from implementation to implementation. Additionally, the actual period used can be fixed per implementation, or may vary over time per implementation, e.g., based on received information from each subscribing client application. In the latter case, the central scheduling function could select the periodicity based on, e.g., an average of the received preferred periodicities received in the subscription messages from the subscribing applications, a weighted average of the preferred periodicities, the least frequent preferred periodicity or the most frequent preferred periodicity.

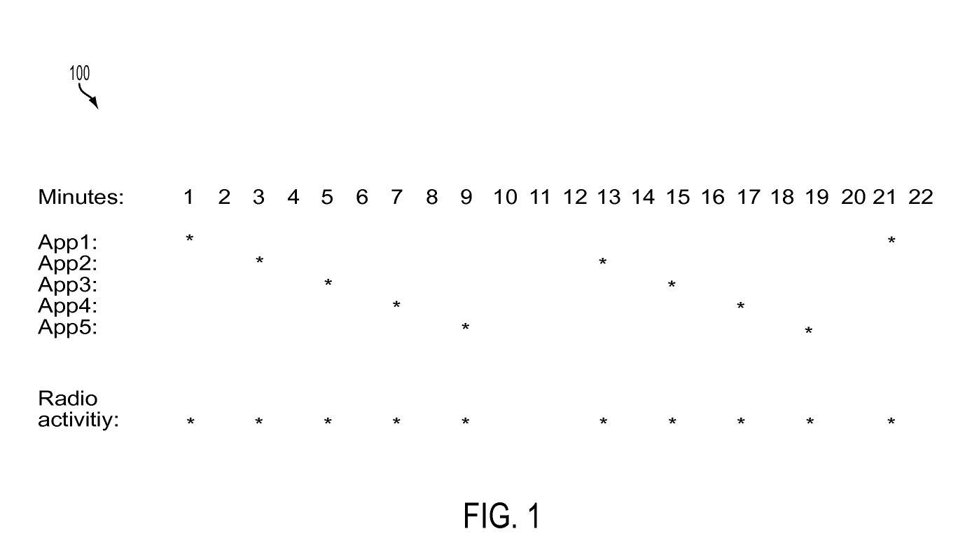

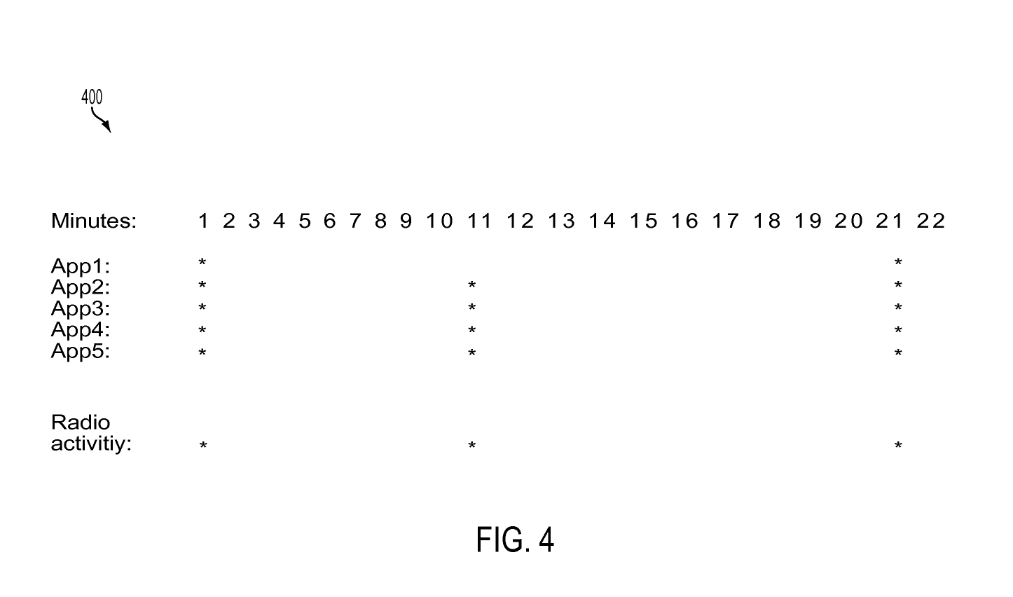

When a subscribing application receives a polling event signal or message, the notified application can then perform polling, e.g., by transmitting a message to the client device 200's processor to wakeup the transceiver (both elements illustrated and described below with respect to FIG. 7) and send a polling signal over the air interface to its respective server, or it can wait until the next polling event. Using polling time notifications and central scheduling, exemplary embodiments avoid the problem of having unsynchronized events. For example, consider the histogram 400 in FIG. 4 in which the same five applications (App1-App5) as described above with respect to FIG. 1 are operating on a single client device, except that in this case their polling requests are controlled by a central scheduling function 300. In this case, each of the five applications receives a polling event message at substantially the same time, and signals the device's processor to request the transmission of a polling signal to its respective server at substantially the same time, resulting in synchronized polling signal transmission. Comparing FIGS. 1 and 4, it can be seen that many fewer radio activity events occur in FIG. 4 when the polling events are regulated/aggregated as compared to the case in FIG. 1 where they are permitted to occur randomly. Even if there are very frequent events, there will not be a very high increase in power consumption using these exemplary embodiments, since the polling frequency does not increase.

The foregoing exemplary embodiment illustrates an example of handling polling (pull) updates. However the present invention is not so limited. For push notifications, traffic aggregation, can also be performed on the server side.

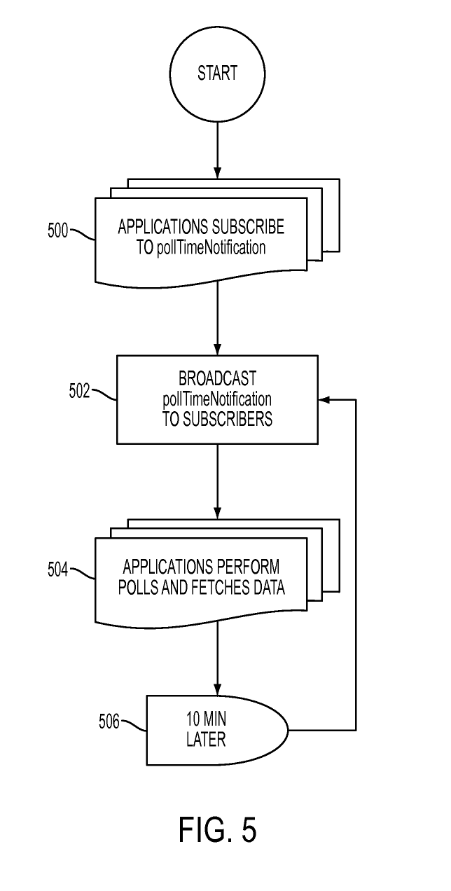

As mentioned above, according to an exemplary embodiment, the pollTimeNotification center or function 300 notifies all subscribing applications about the appropriate time for polling. As shown in FIG. 5, after the client applications subscribe (step 500), a polling notification/authorization can be broadcasted to all of the client applications simultaneously at step 502. Then the applications perform their polling procedures/fetch data at step 504, and the process can be repeated, e.g., every 10 minutes (step 506).

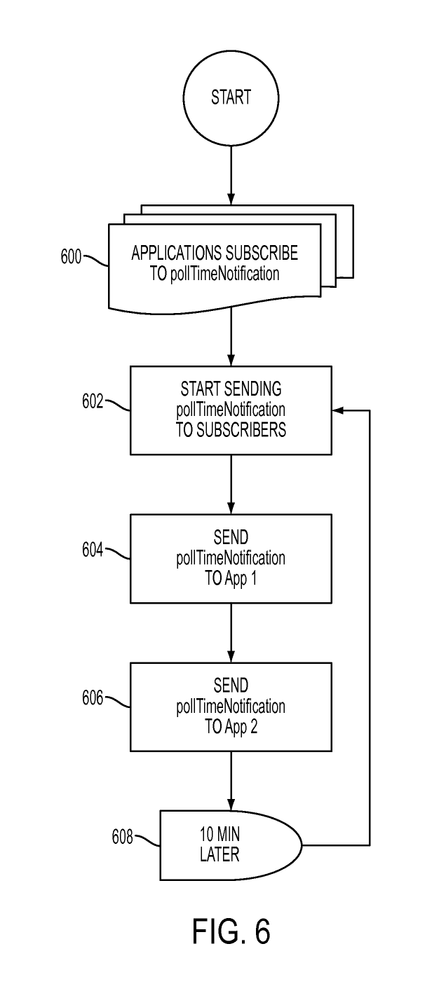

Alternatively, as shown in FIG. 6, the polling event message can be transmitted to each client application sequentially by the central scheduler 300. For example, after the client applications have subscribed (step 600), the central scheduling function 300 can start (step 602) to send pollTimeNotifications (polling messages) when the next polling time occurs by sending sequential messages 604, 606, etc. to each client application authorizing them to start their polling process. This may be beneficial when, for example, there are a large number of applications running simultaneously on the device 200 and it is desirable to avoid a bottleneck if they should otherwise all try to poll their respective servers substantially simultaneously. The process again repeats at the determined periodicity at step 608. Yet another alternative, not illustrated, is an intermediate case where a pool of simultaneous application polls is made to make synchronous sequential polls, e.g., notifying applications in groups rather than individually or all at once.

Usage of controlled polling mechanisms according to these exemplary embodiments may be mandated, e.g., each client application automatically subscribes when it is launched, or may be optional, e.g., each user has the option of using the central scheduler for a particular application or not, however it will be appreciated that the largest savings in terms of power and other resources are achieved if all applications obey this mechanism. It may therefore be advantageous to bind this mechanism to a way of measuring and presenting the network usage, or alternatively, to the battery drain due to network usage of each application to the user. The user can then detect which applications do not behave well, and disable these, e.g., force them to submit to the central scheduler. To save even more power, the system can be disabled when the client device 200 is in a sleep mode, and the central scheduling function 300 can be enabled to send polling events only in the periods when the client device is awake. In the Android framework, the pollTimeNotification could be realized using a broadcast Intent.

According to another exemplary embodiment, in a browser environment where applications are written in JavaScript, the pollTimeNotification service could be exposed as a global object on which the application could register for events that would be dispatched when it is appropriate to poll. These events could both be dispatched in parallel as well as in sequence (synchronously) in all active applications that have registered for the events.

The pollTimeNotification function 300 can be programmed to be informed about any other data transmission/reception which is ongoing, e.g., from the IP stack or by directly being informed about the radio state being changed to an active state. When detecting such an event, the pollTimeNotification function 300 can inform the subscribing applications that it is time to poll, even if the timer for polling has not yet expired. In this way, polling can piggy-back on other activities that awaken the radio transceiver from a low power sleep mode into an awakened, higher power-consuming state. Examples of such activities could be the user requesting a webpage via the browser, the user starting another application or a push-enabled application receiving data via a push channel.

As mentioned above, when subscribing to the pollTimeNotification function 300, each application can indicate information associated with its desired polling periodicity, e.g., the maximum polling interval or periodicity with which it would like to be updated. The pollTimeNotification function 300 can then, for example, select a polling interval that is the minimum of the requested poll interval of all subscribing applications. Alternatively, a weighted mean of all the subscribing applications' requested poll intervals could be used as the interval for the pollTimeNotification service polling interval. The pollTimeNotification function 300 can also provide or expose a user interface which enables the user to change the poll interval, or the minimum allowed poll interval, in one place for all applications. This can allow the user to change the trade-off between battery saving and immediacy. A timer maintained by the pollTimeNotification function 300 can use a value which is established using any of the foregoing (or other) techniques to count down periods between sending polling event messages to the relevant client applications.

Battery drain is one of the main problems with networked applications, and with background network applications in particular in mobile devices. On the other hand, immediate notification is often not needed in a mobile device, since it can be hidden from view, e.g., in the user's pocket, a large part of the time, and therefore immediate presence notifications are not as useful as they are on a desktop PC. Exemplary embodiments provide a means to reduce the background battery consumption by coordinating otherwise sporadic poll traffic to occur in concentrated periods, rather than as random events. Power savings in wireless devices occur by, for example, by reducing the overhead of setting up the radio connection multiple times, and staying in an active radio state for a while after each connection activity.

To provide an incentive to use these exemplary embodiments, a monitor, can be provided e.g., displayed on a display of the client device 20, which shows the battery drain of the network activities of all applications. This may take into account the coordination effects of using one common radio establishment interval for multiple applications.

An exemplary client device 200 can be a mobile device such as the exemplary mobile computing arrangement 700 shown in FIG. 7 which may include a processing/control unit 702, such as a microprocessor, reduced instruction set computer (RISC), or other central processing module. The processing unit 702 need not be a single device, and may include one or more processors. For example, the processing unit 702 may include a master processor and associated slave processors coupled to communicate with the master processor.

The processing unit 702 may control the basic functions of the mobile terminal as dictated by programs available in the storage/memory 704. Thus, the processing unit 702 may execute the functions described above with respect to FIGS. 2-6 to run multiple client applications simultaneously and coordinate communications associated with updating those client applications. More particularly, the storage/memory 704 may include an operating system and program modules for carrying out functions and applications on the mobile terminal. For example, the program storage may include one or more of read-only memory (ROM), flash ROM, programmable and/or erasable ROM, random access memory (RAM), subscriber interface module (SIM), wireless interface module (WIM), smart card, or other removable memory device, etc. The program modules and associated features may also be transmitted to the mobile computing arrangement 700 via data signals, such as being downloaded electronically via a network, such as the Internet.

One of the programs that may be stored in the storage/memory 704 is a specific program 706. As previously described, the specific program 706 may be a client application which interacts with a respective server to obtain updates, and which can coordinate with a central scheduling function to determine when it can initiate an updating process (e.g., polling). The specific program 706 can also represent the central scheduling function itself. The program 706 and associated features may be implemented in software and/or firmware operable by way of the processor 702. The program storage/memory 704 may also be used to store data 708, such as the various authentication rules, or other data associated with the present exemplary embodiments. In one exemplary embodiment, the programs 706 and data 708 are stored in non-volatile electrically-erasable, programmable ROM (EEPROM), flash ROM, etc. so that the information is not lost upon power down of the mobile terminal 700.

The processor 702 may also be coupled to user interface 710 elements associated with the mobile terminal. The user interface 710 of the mobile terminal may include, for example, a display 712 such as a liquid crystal display, a keypad 714, speaker 716, and a microphone 718. These and other user interface components are coupled to the processor 702 as is known in the art. The keypad 714 may include alpha-numeric keys for performing a variety of functions, including dialing numbers and executing operations assigned to one or more keys. Alternatively, other user interface mechanisms may be employed, such as voice commands, switches, touchpad/screen, graphical user interface using a pointing device, trackball, joystick, or any other user interface mechanism.

The mobile computing arrangement 700 may also include a digital signal processor (DSP) 720. The DSP 720 may perform a variety of functions, including analog-to-digital (A/D) conversion, digital-to-analog (D/A) conversion, speech coding/decoding, encryption/decryption, error detection and correction, bit stream translation, filtering, etc. The transceiver 722, generally coupled to an antenna 724, may transmit and receive the radio signals associated with a wireless device.

The mobile computing arrangement 700 of FIG. 7 is provided as a representative example of a computing environment in which the principles of the present exemplary embodiments may be applied. From the description provided herein, those skilled in the art will appreciate that the present invention is equally applicable in a variety of other currently known and future mobile and fixed computing environments. For example, the specific application 706 and associated features, and data 708, may be stored in a variety of manners, may be operable on a variety of processing devices, and may be operable in mobile devices having additional, fewer, or different supporting circuitry and user interface mechanisms. It is noted that the principles of the present exemplary embodiments are equally applicable to non-mobile terminals, i.e., landline computing systems.

An example of a representative computing system capable of carrying out operations in accordance with, for example, the servers of the exemplary embodiments is illustrated in FIG. 8. Hardware, firmware, software or a combination thereof may be used to perform the various steps and operations described herein. The computing structure 800 of FIG. 8 is an exemplary computing structure that may be used in connection with such a system.

The exemplary computing arrangement 800 suitable for performing the activities described in the exemplary embodiments may include server 801, which may correspond to any of servers shown in FIG. 2. Such a server 801 may include a central processor (CPU) 802 coupled to a random access memory (RAM) 804 and to a read-only memory (ROM) 806. The ROM 806 may also be other types of storage media to store programs, such as programmable ROM (PROM), erasable PROM (EPROM), etc. The processor 802 may communicate with other internal and external components through input/output (I/O) circuitry 808 and bussing 810, to provide control signals and the like. The processor 802 carries out a variety of functions as is known in the art, as dictated by software and/or firmware instructions.

The server 801 may also include one or more data storage devices, including hard and floppy disk drives 812, CD-ROM drives 814, and other hardware capable of reading and/or storing information such as DVD, etc. In one embodiment, software for carrying out the above discussed steps, e.g., receiving polling signals and transmitting corresponding updates, may be stored and distributed on a CD-ROM 816, diskette 818 or other form of media capable of portably storing information. These storage media may be inserted into, and read by, devices such as the CD-ROM drive 814, the disk drive 812, etc. The server 801 may be coupled to a display 820, which may be any type of known display or presentation screen, such as LCD displays, plasma display, cathode ray tubes (CRT), etc. A user input interface 822 is provided, including one or more user interface mechanisms such as a mouse, keyboard, microphone, touch pad, touch screen, voice-recognition system, etc.

The server 801 may be coupled to other computing devices, such as the landline and/or wireless terminals and associated watcher applications, via a network. The server may be part of a larger network configuration as in a global area network (GAN) such as the Internet 828, which allows ultimate connection to the various landline and/or mobile, client devices such as that illustrated in FIG. 7.

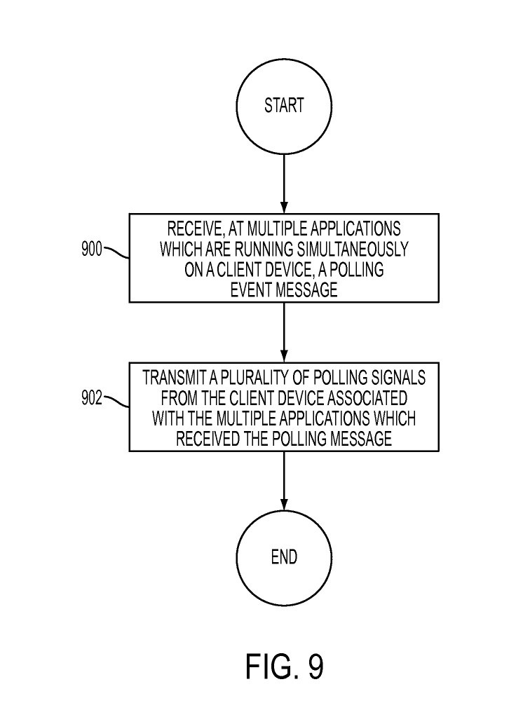

Although the features and elements of the present exemplary embodiments are described in the embodiments in particular combinations, each feature or element can be used alone without the other features and elements of the embodiments or in various combinations with or without other features and elements disclosed herein. The methods or flow charts provided in the present application may be implemented in a computer program, software, or firmware tangibly embodied in a computer-readable storage medium for execution by a general purpose computer or a processor. For example, according to an exemplary embodiment, a method for polling servers from a client device includes the steps illustrated in FIG. 9. Therein, at step 900, a polling event message is received at multiple applications which are running simultaneously on the client device. In response to the polling event, a plurality of polling signals are transmitted from the client device, which polling signals are associated with the multiple applications that received the polling event message, as shown by step 902.

According to another exemplary embodiment, and as described above, a scheduler operates to trigger multiple applications in a synchronized (or otherwise time-optimized) manner to perform network access (e.g., via the Internet) in order to reduce, for example, the total time of radio access and or the total number of times that a radio is turned on. The network connection can, for example, include a network connection which is used to poll a server for new, available data and then to download that data. Alternatively, the network connection can be used to upload content or synchronize content with a server, or another network entity.

The above-described exemplary embodiments are intended to be illustrative in all respects, rather than restrictive, of the present invention. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

1. A method for polling servers from a device comprising:
receiving, at multiple applications which are running simultaneously on the device, a polling event message; and
transmitting, in response to the polling event message, a plurality of polling signals from the device, said polling signals being associated with said multiple applications which received said polling event message.

2. The method of claim 1, wherein each of said polling signals requests updated data or events from servers which each correspond to respective ones of said multiple applications.

3. The method of claim 1, further comprising:
subscribing, by said multiple applications, to a polling signal scheduling service provided by a central scheduling function.

4. The method of claim 3, wherein said step of subscribing further comprises:
sending a subscription message, from each of said multiple applications to said central scheduling function which is operating on said device, said subscription message requesting receipt of said polling event message.

5. The method of claim 4, wherein said subscription message includes information associated with a periodicity at which a respective application requests to receive said polling event message.

6. The method of claim 1, further comprising:
determining a periodicity at which to send said polling event message to said multiple applications.

7. The method of claim 5, further comprising:
determining a periodicity at which to send said polling event message to said multiple applications based upon said information associated with said periodicity at which said respective application requests to receive said polling event message.

8. The method of claim 7, wherein said periodicity is determined based on one of: (1) an average of said periodicity at which each of said respective applications requests to receive said polling event message; (2) a weighted average of said periodicity at which each of said respective applications requests to receive said polling event message, (3) a least frequent preferred periodicity, and (4) a most frequent preferred periodicity.

9. The method of claim 1, wherein said device includes a wireless transceiver, and said step of transmitting further comprises:
exiting, by said wireless transceiver, a low power sleep mode; and
transmitting said polling signal for each of said multiple applications during a time interval prior to re-entering said low power sleep mode.

10. The method of claim 9, further comprising:
disabling a central scheduling function which generates said polling event message when said device is in said low power sleep mode.

11. The method of claim 9, further comprising:
informing said central scheduling function that said wireless transceiver has exited said low power sleep mode; and
sending said polling event message to said multiple applications even if a timer which determines when to send said polling event message has not yet expired.

12. The method of claim 1, wherein said polling event message is broadcast to said multiple applications at the same time.

13. The method of claim 1, wherein said polling event message is sent to each of said multiple applications individually.

14. The method of claim 1, wherein said polling event message is sent to said multiple applications in two or more groups separated in time from one another.

15. A device comprising:
a processor configured to simultaneously execute multiple applications each of which periodically receive updates from respective servers and to execute a central scheduling function which periodically transmits a polling event message to said multiple applications; and
a communication interface configured to transmit, in response to the polling event message, a plurality of polling signals from the device, said polling signals being associated with said multiple applications which received said polling event message.

16. The device of claim 15, wherein said multiple applications are configured to subscribe to said central scheduling function by sending a subscription message, from each of said multiple applications to said central scheduling function which is operating on said device, wherein said subscription message requests receipt of said polling event message.

17. The device of claim 16, wherein said subscription message includes information associated with a periodicity at which a respective application requests to receive said polling event message.

18. The device of claim 15, wherein said central scheduling function is further configured to determine a periodicity at which to send said polling event message to said multiple applications.

19. The device of claim 18, wherein said central scheduling function is further configured to determine a periodicity at which to send said polling event message to said multiple applications based upon said information associated with said periodicity at which said respective application requests to receive said polling event message.

20. The device of claim 19, wherein said periodicity is determined based on one of: (1) an average of said periodicity at which each of said respective applications requests to receive said polling event message, (2) a weighted average of said periodicity at which each of said respective applications requests to receive said polling event message, (3) a least frequent preferred periodicity, and (4) a most frequent preferred periodicity.

21. The device of claim 15, wherein said communication interface includes a wireless transceiver, and said wireless transceiver is further configured to exit a low power sleep mode, and to transmit said polling signal for each of said multiple applications during a time interval prior to re-entering said low power sleep mode.

22. The device of claim 21, wherein said processor is further configured to disable said central scheduling function which generates said polling event message when said device is in said low power sleep mode.

23. The device of claim 21, wherein said processor is further configured to inform said central scheduling function that said wireless transceiver has exited said low power sleep mode, and wherein said central scheduling function is further configured to send said polling event message to said multiple applications even if a timer which determines when to send said polling event message has not yet expired.

24. The device of claim 15, wherein said polling event message is broadcast to said multiple applications at the same time.

25. The device of claim 15, wherein said polling event message is sent to each of said multiple applications individually.

26. The device of claim 15, wherein said polling event message is sent to said multiple applications in two or more groups separated in time from one another.

27. The device of claim 15, further comprising:
a user interface which enables a user of said device to control parameters associated with said central scheduling function.

28. The device of claim 27, wherein said user interface is further configured to display information regarding how controlling polling signals associated with applications which are not currently subscribed to said central scheduling function will impact power consumption by said device.
